(19) United States
(12) Patent Application Publication
(10) Pub. No.: US 2016/0091758 A1
(43) Pub. Date: Mar. 31, 2016

(54) BACKLIGHT UNIT AND LIQUID CRYSTAL DISPLAY DEVICE

(71) Applicant: FUJIFILM Corporation, Tokyo (JP)

(72) Inventor: Hiroyuki YONEYAMA, Kanagawa (JP)

(73) Assignee: FUJIFILM CORPORATION, Tokyo (JP)

(21) Appl. No.: 14/869,272

(22) Filed: Sep. 29, 2015

(30) Foreign Application Priority Data
Sep. 30, 2014 (JP) 2014-202425

(51) Int. Cl. G02F 1/1335; F21K 99/00; H05B 33/08; F21V 9/16

(52) U.S. Cl. CPC G02F 1/133603; F21V 9/16; F21K 9/56; H05B 33/0848; G02F 2001/133614

(57) ABSTRACT

The backlight unit includes two or more light sources, and a wavelength conversion member positioned on each of optical paths of light emitted by the two or more light sources, wherein the wavelength conversion member includes a wavelength conversion layer containing at least a phosphor emitting green light when excited with exciting light and a phosphor emitting red light when excited with exciting light, and at least either maximum emission wavelengths or angles of incidence of entry into the wavelength conversion member of the light emitted by the two or more light sources differ.

### CROSS-REFERENCE TO RELATED APPLICATIONS

This application claims priority under 35 U.S.C 119 to Japanese Patent Application No. 2014-202425 filed on Sep. 30, 2014. The above application is hereby expressly incorporated by reference, in its entirety.

### BACKGROUND OF THE INVENTION

1. Field of the Invention

The present invention relates to a backlight unit, and to a liquid crystal display device equipped with the same.

The present invention further relates to a method of controlling the chromaticity of light emitted by a backlight unit.

2. Discussion of the Background

Flat panel displays such as liquid crystal display devices (also referred to as LCDs (liquid crystal displays), hereinafter) can consume little power and conserve space. Their use as image display devices has been increasing each year. A liquid crystal display device comprises at least a backlight unit and a liquid crystal panel.

Backlight units containing light sources in the form of white light-emitting diodes (LEDs) and other white light sources have been widely employed. By contrast, a new backlight unit has been proposed in recent years that, instead of a white light source, comprises light that is emitted by a light source such as a blue LED and a phosphor that is excited by light emitted by the light source and emits fluorescence, realizing white light by the emission of light from a wavelength conversion member disposed as a separate member from the light source (see Japanese Translated PCT Patent Application Publication (TOKUHYO) No. 2013-544018, which is expressly incorporated herein by reference in its entirety).

More specifically, in the backlight unit described in Japanese Translated PCT Patent Application Publication (TOKUHYO) No. 2013-544018, white light is realized as follows, for example.

Light emitted by a light source enters a wavelength conversion member disposed along the optical path of the light. Of the light that has entered the wavelength conversion member, the light that is absorbed by the phosphor excites the phosphor. The light that passes through the wavelength conversion member without being absorbed by the phosphor exits the wavelength conversion member (emitted light derived from the light source).

The excited phosphor emits light (fluorescence) of a different wavelength from the entering light. For example, when a phosphor that emits green light (a green phosphor) is employed, green light is emitted by the wavelength conversion member. When a phosphor that emits red light (a red phosphor) is employed, red light is emitted by the wavelength conversion member. This makes it possible to obtain emitted light (additional emitted light) that differs in wavelength from the emitted light derived from the light source. By mixing the additional emitted light thus obtained with emitted light derived from the light source (for example, by mixing additional emitted light in the form of green light and red light with emitted light derived from the light source in the form of blue light), it is possible to realize white light.

Depending on the type of flat panel display, the chromaticity of white light that is realized in the above manner can be set. In a liquid crystal display device, when represented by the color coordinates of the chromaticity diagram (CIE1931) specified by the Commission International de l'Eclairage (CIE), the chromaticity of the white light can be set to the white point of x=0.33, y=0.33, for example. As the color coordinates move away from this white point, the white becomes tinted (for example, becoming bluish or yellowish). Thus, the color reproducibility of the image displayed on the liquid crystal display device ends up deteriorating. In this regard, it is stated in Japanese Translated PCT Patent Application Publication (TOKUHYO) No. 2013-544018, paragraph 0175, that the quantity of phosphor added and the like is controlled to achieve a white point.

### SUMMARY OF THE INVENTION

However, even when white light positioned at the white point in the chromaticity diagram is obtained immediately following manufacturing of a backlight unit in which the quantity of phosphor added and the like has been controlled, the white light that is emitted by the backlight unit will sometimes become tinted following an extended period of use. The reason for this is thought to be a decrease in light emitting efficiency due to deterioration of the phosphor over time, for example. More specifically, the following may take place. For example, in a backlight unit equipped with a light source emitting blue light and a wavelength conversion member containing a green phosphor and a red phosphor, when the phosphors deteriorate and the light emitting efficiency decreases, the amount of green light and red light decreases relative to the amount of blue light being emitted by the light source. Thus, the white light that is obtained by mixing these lights appears bluish.

Further, when the performance (such as the light-emitting efficiency of the phosphor) differs by lot in the phosphors actually employed in mass production from the phosphor employed to actually determine the manufacturing conditions for mass production, the balance between the amount of emitted light derived from the light source and the amount of additional emitted light ends up changing from what it was when the manufacturing conditions were determined, and the white light that is emitted by the backlight unit can conceivably become tinted.

Scattering and changes in absorption of light by members constituting the backlight unit may also conceivably cause tinting of the white light emitted by the backlight unit. For example, when the members constituting the backlight unit deteriorate over time and a transparent member becomes yellowish, the balance between the amount of blue light emitted by the light source and the amount of additional emitted light ends up changing, and the white light that is emitted by the backlight unit may conceivably become tinted.

As set forth above, the tinting of white light obtained from a backlight unit equipped with a wavelength conversion member could conceivably occur for a variety of reasons. However, controlling the amount of phosphor added and the like during the manufacturing of the wavelength conversion member as is described in Japanese Translated PCT Patent Application Publication (TOKUHYO) No. 2013-544018 does not make it possible to eliminate or moderate the tinting of white light caused by deterioration of the phosphors over time. Further, eliminating the tinting of white light due to absorption or reflection of light by the constituent members of the backlight unit or variation in performance between phosphor lots by controlling the quantity of phosphor added and the like during the manufacturing of the wavelength conversion member as is described in Japanese Translated PCT Patent Application Publication (TOKUHYO) No. 2013-544018 requires establishing the quantity of phosphor added for each manufacturing lot so as to obtain white light positioned at the white point in the chromaticity diagram, rendering the manufacturing process complex and compromising productivity.

An aspect of the present invention provides for a new means of eliminating or moderating the tinting of white light obtained from a backlight unit equipped with a wavelength conversion member.

An aspect of the present invention relates to:

a backlight unit, comprising:

two or more light sources, and

a wavelength conversion member positioned on each of the optical paths of the light emitted by the two or more light sources, wherein

the wavelength conversion member comprises a wavelength conversion layer containing at least a phosphor emitting green light when excited with exciting light and a phosphor emitting red light when excited with exciting light; and

at least either the maximum emission wavelengths or the angles of incidence of entry into the wavelength conversion member (also referred to simply as the “angles of incidence”, hereinafter) of the light emitted by the two or more light sources differ.

Each of the two or more light sources can be in the form of a single light source (such as a single light-emitting diode (LED)) or in the form of a group of two or more light sources of identical maximum emission wavelengths and angles of incidence.

In one embodiment, the maximum emission wavelengths of the two or more light sources are within a range from the wavelength range of blue light to the wavelength range of ultraviolet light. In the present invention and in the present specification, light having a maximum emission wavelength in the 430 nm to 490 nm wavelength range is referred to as blue light, and light having a maximum emission wavelength in the wavelength range of longer than or equal to 365 nm but less than 430 nm is referred to as ultraviolet light. Light having a maximum emission wavelength in the 520 nm to 560 wavelength range is referred to as green light, and light having a maximum emission wavelength in the 600 nm to 680 nm wavelength range is referred to as red light. The “full width at half maximum” of the peak refers to the width of the peak at one half the height of the peak. The light of a single peak of a light source emitting blue light is called a blue light source, and the light of a single peak of a light source emitting ultraviolet light is called an ultraviolet light source. The emission of light of a single peak refers not to the appearance of two or more peaks such as in the case of a white light source, but rather means that only a single peak, having the maximum emission wavelength as its center emission wavelength, is present.

In one embodiment, the backlight unit comprises a control element that is capable of controlling the intensity of light emitted by at least one of the two or more light sources independently of the intensity of the light emitted by another light source. When the light source is a group of light sources containing two or more light sources of identical maximum emission wavelengths and angles of incidence as set forth above, it suffices for the control element to be able to control the intensity of the light emitted by at least one of the light sources classified as being in the same group of light sources independently of the intensity of the light emitted by a light source classified as being another light source, or for it to be able to independently control the intensity of the light emitted by two or more light sources classified as being in the same group of light sources. This embodiment also covers an embodiment in which individual light sources among all the light sources classified as being in the same group of light sources are not independently controlled, but the intensity of the light emitted by all the light sources classified as being in the same group of light sources is collectively controlled (but controlled independently of the intensity of the light emitted by light sources classified as being another group of light sources). The term “that can be independently controlled” means that the intensity of the light emitted by a specific light source can be adjusted independently of the intensity of the light emitted by other light sources. The control element that is capable of conducting the above independent control can output a signal that can adjust the intensity of the light emitted by one light source among two or more light sources without changing the intensity of the light emitted by the other light sources. Changing the intensity of the light emitted includes increasing or decreasing, continuously or in stages, the intensity of the light emitted, turning off while other light sources are on, and conversely, turning on while other light sources are off.

In one embodiment, the control element can control the intensity of the light emitted by each of the two or more light sources independently of the intensity of the light emitted by the other light sources.

In one embodiment, the maximum emission wavelengths of the two or more light sources differ. This embodiment covers embodiments where the maximum emission wavelength of the other light source is to the long wavelength side of the maximum emission wavelength of a given light source, and embodiments where it is to the short wavelength side.

In one embodiment, the light source is a light-emitting diode and the wavelength conversion member is a sheet-shaped member.

In one embodiment, the backlight unit comprises at least one member having a reflective property at least on the emission side (that is, the liquid crystal cell side in a state disposed in a liquid crystal display device) or on the light source side. The member having a reflective property is a sheet-shaped member, in one embodiment.

Backlight units can be roughly divided into direct under type backlight units and edge-light type backlight units. The above backlight unit can be either type of backlight unit. In one embodiment, the backlight unit is a direct under type backlight unit.

In one embodiment, the backlight unit contains a chromaticity measuring element that measures the chromaticity of the light emitted by the wavelength conversion member.

In one embodiment, the backlight unit contains a control element that changes the intensity of the light emitted by at least one of the two or more light sources based on the chromaticity that is measured by the chromaticity measuring element.

A further aspect of the present invention relates to a liquid crystal display device comprising the above backlight unit and a liquid crystal panel.

A further aspect of the present invention relates to:

a method of controlling the chromaticity of light emitted by a backlight unit, wherein

the backlight unit is the above backlight unit, and

the method comprising:

evaluating the chromaticity of light emitted by the backlight unit;

determining whether the evaluated chromaticity falls within a permissible range or outside the permissible range; and

when determined to fall outside the permissible range based on the determination results, changing the intensity of the light emitted by at least one of the two or more light sources to bring the chromaticity of the light emitted by the backlight unit within the permissible range.

An aspect of the present invention can eliminate or moderate, by a simple means of changing the intensity of the light emitted by a light source, the tinting of white light emitted by a backlight unit that is thought to occur for various reasons.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the drawing, wherein:

FIG. 1 is a descriptive drawing showing a partial configuration of an example of a backlight unit.

FIG. 2 is a descriptive drawing of a method of controlling chromaticity.

FIG. 3 shows the positions on the chromaticity diagram of white light emitted by backlight units in Examples and Comparative Examples set forth further below.

### DETAILED DESCRIPTION OF THE EMBODIMENTS

The description given below is based on a representative mode of implementing the present invention. However, the present invention is not limited to such implementation modes. In the present invention and in the present specification, a number range stated using the word “to” signifies a range that includes the preceding and succeeding numeric values as minimum and maximum values, respectively.

The backlight unit according to an aspect of the present invention comprises two or more light sources, and a wavelength conversion member positioned on each of the optical paths of the light emitted by the two or more light sources; wherein the wavelength conversion member comprises a wavelength conversion layer comprising at least a phosphor emitting green light when excited with exciting light and a phosphor emitting red light when excited with exciting light; and at least either the maximum emission wavelengths or the angles of incidence of entry into the wavelength conversion member of the light emitted by the light sources differ.

The present inventor conducted extensive research into providing the new means of eliminating or moderating the tinting of white light obtained from a backlight unit equipped with a wavelength conversion member. As a result, he discovered the backlight unit of an aspect of the present invention. The presumptions by the present inventor relating to why tinting of white light can be eliminated or moderated by the above backlight unit will be described below with reference to the drawings.

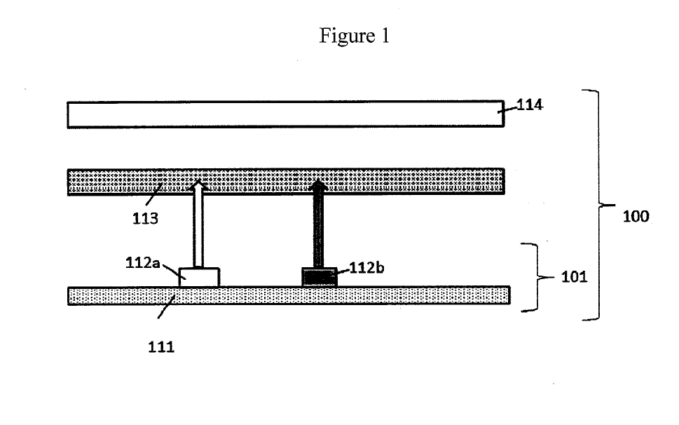

FIG. 1 is a descriptive drawing showing the partial configuration of an example of a backlight unit. The backlight unit 100 shown in FIG. 1 is a direct under type backlight unit that comprises a reflective plate (member having a reflective property) 111, a light emitting element 101 comprising a light source 112a and a light source 112b with a maximum emission wavelength differing from that of light source 112a, and a wavelength conversion member 113. Two light sources are shown in the figure by way of example. However, the number of light sources present in the backlight unit of an aspect of the present invention is not limited to 2. As set forth above, each of the two or more light sources can be a single light source or can be a group of light sources containing two or more light sources of identical maximum emission wavelengths and angles of incidence.

As indicated by the arrows in FIG. 1, wavelength conversion member 113 is positioned on the optical paths of the light emitted by the light sources. Accordingly, the light emitted by light source 112a and the light emitted by light source 112b both enter wavelength conversion member 113. The wavelength conversion member comprises a wavelength conversion layer containing at least a phosphor that is excited with exciting light and emits green light and a phosphor that is excited with exciting light and emits red light. A portion of the light entering form each of the light sources is absorbed by these phosphors, excites the phosphors, and causes them to emit fluorescence. Further, of the light entering from the light sources, the light that is not absorbed by the phosphors passes through the wavelength conversion member. At least a portion of the light that has passed through is normally reflected by a member (numeral 114 in the figure) having a reflective property that is normally positioned on the emission side (the side of the liquid crystal panel when disposed on a liquid crystal display panel) of the wavelength conversion member. This light reenters the wavelength conversion member and either excites the phosphors or passes through the wavelength conversion member, reflects off the member having a reflective property of reflective plate 111 of light emitting element 101, and once again enters the wavelength conversion member. Normally, the light emitted by the light sources repeats this reflecting and entering multiple times. In an embodiment comprising a blue light source as at least one the two or more light sources, for example, of the light that is emitted by the light sources, the blue light that is finally emitted to the emission side of the backlight unit and the green and red light that is emitted by the phosphors are mixed, thereby realizing white light. In an embodiment comprising a phosphor that is excited with exciting light and emits blue light in the wavelength conversion layer, white light can be realized by the mixing of red light, green light, and blue light emitted by the excited phosphor.

In this context, focusing on the emission properties of the phosphor, in the light emitted by phosphors represented by quantum dots, described in detail further below, the intensity of the light emitted increases as the wavelength of the exciting light in the ultraviolet to blue light range shortens. The intensity of the light emitted tends to decrease as the wavelength of the exciting light lengthens. In one embodiment of the present invention, this characteristic of light emission by the phosphor can be utilized to eliminate or moderate the tinting of white light. The details are given below.

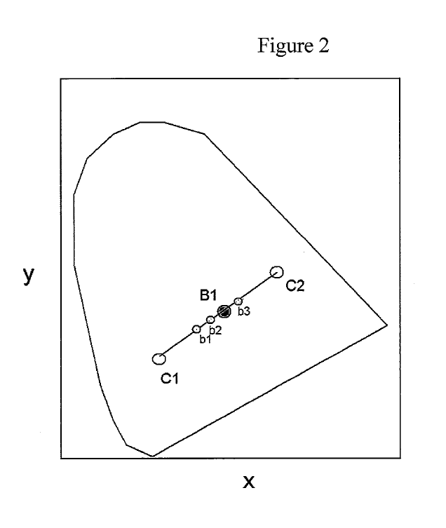

FIG. 2 is a descriptive drawing of the method of controlling chromaticity. It shows a simplified version of the above chromaticity diagram. In the figure, B1 denotes desirable white light. When the white light at chromaticity point B1 is realized with just one light source, the white light will sometimes develop a tint due to the various reasons set forth above. For example, when a blue tint develops, the white light on the chromaticity diagram shifts to chromaticity point b1 or b2. When a yellow tint develops, the white light shifts to chromaticity point b3 in the chromaticity diagram.

By contrast, in a backlight unit containing two blue light sources of differing maximum emission wavelengths, for example, focusing on the wavelength dependency of the light emission characteristics of the phosphors, among the two light sources, the blue light that is emitted by the light source emitting blue light of shorter wavelength is relatively intense with respect to the emission intensity of the green light and red light by the phosphors. Thus, it is possible to impart intensely yellowish white light (chromaticity point C2 in FIG. 2) by mixing with the green light and red light. Conversely, the blue light that is emitted by the light source that emits blue light of longer wavelength, is relatively weak with respect to the intensity of the green light and red light emitted by the phosphors. Thus, mixing with the green light and red light results in a weakly yellowish, that is, an intensely bluish white light (chromaticity point C1 in FIG. 2). By adjusting the emission intensity of the two light sources, it is possible to mix a color on the line segment connecting chromaticity points C1 and C2 in FIG. 2. This makes it possible to adjust the chromaticity of white light to the desirable chromaticity point B1.

Accordingly, when the chromaticity point of the white light obtained shifts from the desirable chromaticity point B1 to b1, b2 or b3 due to some reasons, the chromaticity of the light emitted can be adjusted on the line segment connecting chromaticity points C1 and C2 by adjusting the balance of the intensity of light emitted by the light source that yields the chromaticity point C1 and the intensity of light emitted by the light source that yields the chromaticity point C2. This makes it possible to eliminate or moderate the tinting of white light. Such eliminating and mitigating of tinting is impossible in a backlight unit equipped with just one light source. As set forth above, the light that is emitted by the light sources enters the wavelength conversion layer and is absorbed by the phosphor, becoming the exciting light of the phosphor and causing the phosphor to emit light.

An embodiment employing two light sources of differing maximum emission wavelengths has been given above by way of example. However, the light sources that are contained in the backlight unit can be three or more differing light sources that differ in at least their maximum emission wavelengths or angles of incidence. When three or more light sources are employed, in the same manner as above, it is possible to achieve white light with a desirable chromaticity point B1 by adjusting the balance of the emission intensities of the individual light sources so as to impart a different chromaticity point. For example, in an embodiment employing three light sources of differing maximum emission wavelengths, it is possible to achieve white light with a desirable chromaticity point by selecting the maximum emission wavelength of the three light sources and adjusting the emission intensities of the light sources to mix colors so that chromaticity point of desirable white light lies within the triangle formed by the three chromaticity points on the chromaticity diagram.

A description of an embodiment employing two or more light sources having differing maximum emission wavelengths has been given above. However, it is also possible for the light emitted by light sources having the same maximum emission wavelength to have two or more different angles of incidence of entry into the wavelength conversion member. In an embodiment employing two or more such light sources, the length of the optical paths in the wavelength conversion layer increases as the angle of incidence of the light emitted increases. The longer the optical path becomes, the greater the probability that the light emitted by the light sources will be absorbed by the phosphors in the wavelength conversion layer becomes. By using light sources that emit light at a larger angle of incidence, it is possible to increase the emission intensity of the fluorescence emitted by the excited phosphors (that is, strengthen the emission intensity of green light and red light), and achieve intensely yellowish white light as the emission light. Conversely, by using light sources that emit light at smaller angles of incidence (close to perpendicular), the intensity of the green light and red light emitted weakens and intensely bluish white light can be achieved as the emission light. The use of two or more light sources of differing optical path lengths in the wavelength conversion layer also makes it possible to eliminate and moderate the tinting of white light. Such eliminating and moderating of tinting is impossible in a backlight unit equipped with just type of one light source.

An aspect of the present invention as set forth above makes it possible to eliminate or moderate the tinting of white light by a simple means of adjusting the intensity of the light emitted by two or more light sources having at least differing maximum emission wavelengths or angles of incidence.

However, the above descriptions contain presumptions by the present inventor and are not intended to limit the present invention in any way.

An aspect of the present invention will be described in greater detail below.

<Light Sources>

The light sources contained in the backlight unit are two or more light sources having at least differing maximum emission wavelengths or angles of incidence. An example of an embodiment employing two light sources has been given above. However, it is also naturally possible to employ three or more light sources, as stated above. It is also possible for both the maximum emission wavelengths and the angles of incidence of the two or more light sources to differ.

The backlight unit contains a phosphor that is excited with exciting light and emits green light (also referred to as a “green phosphor”, hereinafter) and a phosphor that is excited with exciting light and emits red light (also referred to as a “red phosphor”, hereinafter). When a blue light source is employed as at least one of the light sources, white light can be obtained by mixing blue light that is emitted by the blue light source, passes through the wavelength conversion layer, and is emitted by the backlight unit, green light that is emitted by the green phosphor, and red light that is emitted by the red phosphor as light emitted by the backlight unit. When the wavelength conversion layer contains a phosphor that is excited by light and emits blue light (also referred to as a “blue phosphor”, hereinafter) in addition to the green phosphor and red phosphor, it is possible to obtain white light as the light emitted by the backlight unit by mixing blue light emitted by the blue phosphor, green light emitted by the green phosphor, and red light emitted by the red phosphor by incorporating a light source in the form of an ultraviolet light source, for example, and using ultraviolet light as exciting light, even without incorporating a blue light source as a light source. Phosphors have the property of being excited by light of shorter wavelength than the light they emit. Accordingly, the exciting light is not limited to light that enters the wavelength conversion layer from outside the wavelength conversion layer. It is also possible for the phosphor to be excited by fluorescence emitted within the wavelength conversion layer and emit light.

The maximum emission wavelengths of the individual light sources when employing two or more light sources of differing emission wavelength desirably fall within a range from the blue light wavelength range to the ultraviolet light wavelength range so as to excite at least some of the phosphors contained in the wavelength conversion layer. Examples of preferred combinations are given below. Combining a light source emitting light of shorter wavelength with a light source emitting light of longer wavelength makes it possible to eliminate or moderate the tinting of white light by controlling the intensity of the light emitted by at least one of the light sources, as set forth above.

(1) The maximum emission wavelength of at least one light source falls within a wavelength range of 365 nm to 460 nm, and the maximum emission wavelength of at least one light source falls within a wavelength range of 430 nm to 490 nm, with the wavelength of the former being shorter than that of the latter;
(2) The maximum emission wavelength of at least one light source falls within a wavelength range of 420 nm to 450 nm, and the maximum emission wavelength of at least one light source falls within a wavelength range of 430 nm to 490 nm, with the wavelength of the former being shorter than that of the latter;
(3) The maximum emission wavelength of at least one light source falls within a wavelength range of 365 nm to 430 nm, and the maximum emission wavelength of at least one light source falls within a wavelength range of 430 nm to 490 nm, with the wavelength of the former being shorter than that of the latter;
(4) The maximum emission wavelength of at least one light source falls within a wavelength range of 365 nm to 420 nm, and the maximum emission wavelength of at least one light source falls within a wavelength range of 390 nm to 430 nm, with the wavelength of the former being shorter than that of the latter;

In a backlight unit containing two blue light sources of differing maximum emission wavelengths, the maximum emission wavelengths of the two blue light sources desirably differ by 5 nm or more, preferably differ by 10 nm or more, and more preferably, differ by 15 nm to 40 nm.

The light sources are not specifically limited. Light-emitting diode (LED) and laser light sources are desirable. Light-emitting diodes having a maximum emission wavelength falling within a range from the wavelength range of blue light to the wavelength range of ultraviolet light are desirable. Among these, light-emitting diodes of an InGaN-based material are desirable due to the ease of adjusting the light-emitting characteristics by varying the level of In doping.

It is also possible to employ a light source in the form of a light-emitting diode having a maximum emission wavelength falling within the range of the wavelength range of blue light to the wavelength range of ultraviolet light in combination with a phosphor such as a green phosphor, a yellow phosphor (a phosphor represented by an yttrium aluminum garnet (YAG) phosphor with a full width at half maximum of about 50 nm to 150 nm at a maximum emission wavelength of 520 nm to 600 nm), and a red phosphor, for example, a light source in which phosphors have been coated on the surface of light-emitting diodes. Peaks also appear at the center emission wavelength of the phosphor in addition to peaks where the maximum emission wavelength is the center emission wavelength of a light-emitting diode in the emission spectra of light emitted by such a light source.

A blue light source or an ultraviolet light source emitting light with a single peak is desirable as a light source.

By way of example, the angles of incidence of entry into the wavelength conversion member of light emitted by the individual light sources in the case of a combination of two or more light sources of differing angles of incidence can be, for example, a combination where the angle of incidence of one of the light sources is perpendicular (0°) to the surface of the wavelength conversion member and the angle of incidence of another light source is 30° relative to the surface of the wavelength conversion member, a combination where the latter is 45°, or a combination where the latter is 60°. However, these are but examples. Since it suffices for the angle of incidence of one of the light sources to differ from the angle of incidence of the other light sources to impart a difference to the length of the optical path as set forth above, no limitation is specified for the angle of incidence. In the present invention and present specification, angles (such as “30°”, “45°”, and “60°”) and relations between angles (such as “perpendicular”) fall within the range of error that is permissible in the technical field to which the present invention belongs. For example, they mean within a range of the precise angle ±10°, and desirably an error of less than or equal to 5° with the precise angle. The individual light sources can have an angle of incidence distribution. For example, they can have a distribution of 10° to 30° in the full width at half maximum. In that case, the angle of incidence refers to the angle yielding the peak intensity.

<Wavelength Conversion Member>

The wavelength conversion member comprises at least a wavelength conversion layer. The wavelength conversion layer is a layer that can emit light of differing wavelength from the light that enters the layer (can convert the wavelength). The above wavelength conversion member of the backlight unit can emit green light, red light, and optionally blue light by containing a green phosphor and red phosphor, and optionally a blue phosphor, in the wavelength conversion layer. The fact that white light can be obtained as the light emitted by the backlight unit equipped with a wavelength conversion member having such a wavelength conversion layer has been described in detail above.

(Phosphors)

Any phosphor capable of being excited with exciting light and emitting fluorescence can be employed without limitation as a phosphor that is contained in the wavelength conversion layer. The phosphor is normally capable of emitting fluorescence with a single peak with the maximum emission wavelength as the center emission wavelength. It is possible to realize white light by mixing monochromatic light having such a single peak as set forth above. Desirable phosphors include quantum dots (QDs, also referred to as quantum points) and quantum rods, which are phosphors that adopt discrete energy levels due to quantum confinement effects. In contrast to the fluorescence in the form of polarization light that is emitted by quantum rods when excited with exciting light, the fluorescence that is emitted by quantum dots when excited with exciting light does not have the characteristics of polarization light (and is referred to as omnidirectional light and non-polarization light). The full width at half maximum of the fluorescence that is emitted by quantum dots and quantum rods is smaller than that of the fluorescence of other phosphors. Thus, the white light that is obtained using light emitted by them can afford good color reproducibility, making these phosphors desirable. The full width at half maximum of the fluorescence of quantum dots and quantum rods is desirably less than or equal to 100 nm, preferably less than or equal to 80 nm, more preferably less than or equal to 50 nm, still more preferably less than or equal to 45 nm, and yet still more preferably, less than or equal to 40 nm. The emission wavelength of quantum dots and quantum rods can normally be adjusted by means of composition, size, or both.

Quantum rods also have a greater Stokes shift than quantum dots. For example, when emitting the same red fluorescence, they have a property whereby the absorption end shifts to a short wavelength. Thus, even when a phosphor (green phosphor) emitting green light is also present in a single wavelength conversion layer, reabsorption of the green light from the green phosphor can be decreased, affording the advantage of greatly increasing the amount of green light emitted by the backlight unit. Further, multiple excitation due to repeated emission and excitation between phosphors tends not to occur with quantum rods. This is desirable from the perspective of improving the efficiency of energy use. Compared to other phosphors, in the quantum rods, contribution of the green light to the intensity of red light emitted when the quantum rods are excited is little while contribution of the light in the wavelength range of blue light to ultraviolet light is great. This point is desirable from the perspective of ease of adjusting the chromaticity of white light.

Quantum dots are, for example, particles of semiconductor crystals (semiconductor nanocrystals) with a nano-order size; particles obtained by modifying the surface of semiconductor nanocrystals with organic ligands; particles obtained by modifying the surface of semiconductor nanocrystals with inorganic components, or particles obtained by covering the surface of semiconductor nanocrystals with a polymer layer. Quantum dots can be synthesized by known methods. They are also available as commercial products. For details, reference can be made to US 2010/123155A1, Japanese Translated PCT Patent Application Publication (TOKUHYO) No. 2012-509604, U.S. Pat. No. 8,425,803, Japanese Unexamined Patent Publication (KOKAI) No. 2013-136754, WO2005/022120, and Japanese Translated PCT Patent Application Publication (TOKUHYO) Nos. 2006-521278, 2010-535262, and 2010-540709, for example. The contents of the above publications are expressly incorporated herein by reference in their entirety.

With regard to quantum rods, reference can be made to Japanese Translated PCT Patent Application Publication (TOKUHYO) No. 2014-502403, paragraphs 0005 to 0032 and 0049 to 0051; U. S. Pat. No. 7,303,628; an article (Peng, X. G.; Manna, L.; Yang, W. D; Wickham, J.; Scher, E.; Kadavanish, A.; Alivisatos, A. P.; Nature 2000, 404, 59-61); an article (Mann, L.; Scher, E. C.; Alivisatos, A. P; J. Am. Chem. Soc. 2000, 122, 12,700-12,706), for example. The contents of the above publications are expressly incorporated herein by reference in their entirety. They are also available as commercial products.

The wavelength conversion layer is normally a layer containing the above-described phosphors in a matrix. The method of preparing the wavelength conversion layer is not specifically limited. For example, a polymerizable composition containing a polymerizable compound with phosphors, and optionally containing one or more additives such as polymerization initiators is coated on a suitable substrate and subjected to a polymerization treatment to form a wavelength conversion layer in the form of a cured layer. The wavelength conversion member can be of any form, such as a sheet, film, or bar. The wavelength conversion member can be comprised solely of a wavelength conversion layer, or can contain one or more optional members such as a substrate or barrier film. Reference can be made to Japanese Translated PCT Patent Application Publication (TOKUHYO) No. 2013-544018, which is expressly incorporated herein by reference in its entirety, regarding optional members that can be incorporated, for example.

In an aspect of the present invention, to achieve wavelength conversion with a small quantity of phosphor, it is desirable for the wavelength conversion member to be in the form of a sheet to effectively excite the phosphors in addition to employing optional members in the backlight unit, described further below. In the present invention and present specification, the term “in the form of a sheet” or “sheet-shaped” is used synonymously with the term “in the form of a film” or “film-shaped”.

<Optional Members in the Backlight Unit>

The backlight unit contains at least the above-described light sources and wavelength conversion member. It can also optionally contain one or more other members. The various members that can be optionally contained are described below.

The backlight unit normally contains a reflective member and a light-emitting element comprising a light source in addition to the wavelength conversion member. One or more members selected from the group consisting of diffusion members and light-guiding members are normally disposed on the emission side (wavelength conversion member side) of the backlight unit. Backlight units are classified as direct under type edge-light type based on the configuration of the light-emitting element. A direct under type backlight unit normally comprises at least a reflecting member, multiple light sources disposed on the reflecting member, and a diffusing member (normally referred to as a diffusion plate, diffusion sheet, or the like) that diffuses and emits light generated by the light sources. In an edge-light backlight unit, light sources are normally disposed on the side surface of a light-guiding member (normally referred to as a light-guiding plate), and a reflecting member is disposed on the opposite side of the light-guiding member from the emission side. A diffusing member is sometimes disposed on the emission surface side of the light-guiding member. The light-guiding member can be used to adjust the angle of incidence of entry into the wavelength conversion member of light emitted by the light sources. The backlight unit of an aspect of the present invention can be a direct under type backlight unit or an edge-light backlight unit. From the perspective of ease of positioning the two or more light sources, a direct under type backlight unit is desirable.

The backlight unit can also comprise one or more members with a light-scattering function such as a reflective sheet and a scattering sheet, members having a light-collecting function such as a prism sheet, brightness enhancement films, and the like in any position.

In an embodiment employing two or more light sources of differing maximum emission wavelengths as light sources, the reflective sheet can have different reflectance for different maximum emission wavelengths. A reflective sheet can also be provided by a known printing method in the form of a pattern such as an irregular shape to adjust the full or partial reflectance. When nonuniformity of light intensity or a pattern ends up being formed in the surface of the backlight unit, it is possible to employ a dye, pigment, ultraviolet absorbing-agent, or the like to print a pattern to partially adjust reflection of the exciting light within the surface.

The member having a scattering function is a scattering sheet, in one embodiment. In another embodiment, particles having a light-scattering property (scattering particles) can be added to any member (the wavelength conversion layer, a barrier film laminated on the wavelength conversion layer, a prism sheet, an adhesive layer for the adhesion between members, or the like) to impart a scattering function. The scattering function can be imparted, for example, to the protective film of a polarizer on the backlight side of a liquid crystal panel, described further below.

A known prism sheet such as a prism sheet having multiple prism arrays disposed in parallel on one surface can be employed as the prism sheet. For example, two prism sheets can be stacked so that the prism arrays are at right angles to each other while the prism arrays of the two prism sheets face in the same direction for use. With such a prism sheet, it is possible to achieve the function of collecting light that has emitted from the wavelength conversion member to the liquid crystal panel side by disposing the prism arrays facing the emission side on the emission side (liquid crystal panel side when disposed in a liquid crystal display device) of the wavelength conversion member in a backlight unit, for example. The prism sheet desirably absorbs little fluorescence emitted by the phosphors and little light emitted by the light sources. For this reason, glass can be used as the material of the prism sheet. However, there is no limitation to glass. It is also desirable to employ various resin materials as the material of the prism sheet.

Various materials that are capable of enhancing the brightness of the display surface of the liquid crystal display device when incorporated into it can be employed as the brightness enhancement film. An example of a brightness enhancement film is a reflective polarizer. The term “reflective polarizer” means a polarizer that passes light oscillating in a specific direction of polarization and reflects light oscillating in other directions of polarization.

The various members set forth above can all be prepared by known methods or employed in the form of commercial products.

Most of the above members have the property of reflecting light (reflectivity). Thus, when light that is emitted by the light sources is reflected by these reflective members, multiple reflection and incidence takes place repeatedly, as set forth above. This can contribute to the efficient entry of light emitted by the light sources into the wavelength conversion layer. Thus, light emitted by the light sources can become exciting light and fluorescence can be emitted. This can contribute to increasing the intensity of emission of fluorescence produced with exciting light in the form of the fluorescence thus emitted. This is effective in terms of enhancing the brightness of the display surface of the liquid crystal display device. This is also effective in that high-intensity emission can be achieved with less phosphor. Additionally, multiple repeated reflection and incidence may suggest that various factors due to many components lie behind the ultimate change in chromaticity of the white light. By contrast, the backlight unit of an aspect of the present invention employs two or more light sources as set forth above, thereby eliminating or moderating the tinting of white light by a simple means of adjusting the intensity of emission of the light sources.

<Specific Embodiments of Controlling the Chromaticity of Emitted Light>

Specific embodiments of controlling the chromaticity of emitted light that is emitted by the above backlight unit will be described next. However, the following are merely examples and there is no intent to limit the present invention to the specific embodiments given below.

(Evaluation and Determination of Chromaticity of Light Emitted)

In one embodiment, the chromaticity of the light that is emitted by the backlight unit is measured by a known colorimeter and using digitization to obtain color coordinates on a chromaticity diagram or the like. However, embodiments in which an objective evaluation is not performed by digitization, but rather the chromaticity is subjectively evaluated by organoleptic evaluation are also examples. For example, the actual color displayed by a liquid crystal display device equipped with a backlight unit can be evaluated by organoleptic evaluation of an observer to evaluate the chromaticity from the backlight unit.

In one embodiment, a determination is made as to whether the results of chromaticity evaluation obtained by digitization fall within or outside a preset permissible range.

In another embodiment, a determination is made by an observer as to whether the results of organoleptic chromaticity evaluation fall within or outside a permissible range.

When the chromaticity of the emitted light is determined to fall within the permissible range by either form of evaluation, a determination is made that white light free of tinting (or with a permissible level of tinting) can be obtained from the backlight unit without changing the initial setting of the intensity of the light emitted by the two or more light sources contained in the backlight unit.

However, when the chromaticity of the emitted light is determined to fall outside the permissible range by either form of evaluation, the initial setting of the intensity of the emitted light of at least one of the two or more light sources contained in the backlight unit is changed and the chromaticity of the light emitted by the backlight unit is adjusted to within the above permissible range.

The above evaluation and determination can be done manually, or part or all of the process can be done automatically. For example, the evaluation and determination in the above organoleptic evaluation can be done manually. Additionally, in digitized evaluation and determination, for example, a light-receiving element can be provided in the backlight unit or in the liquid crystal display device into which it is mounted, and the light-receiving element can measure the chromaticity of light that is received by means of a chromaticity measuring element such as a colorimeter. The light-receiving element can be provided at any location to the emission side (liquid crystal panel side) of the wavelength conversion member of the backlight unit. It can also be provided at any position on the liquid crystal panel. Further, light-receiving elements can be provided at two or more different positions, and a representative value of the chromaticity of light received by multiple light-receiving elements such as the average, maximum value, or minimum value can be used to evaluate the chromaticity and make the determination.

(Adjusting the Chromaticity)

The chromaticity of the emitted light can be adjusted, as described with reference to the figures above, by changing the intensity of the light emitted by at least one of two or more light sources having at least differing maximum emission wavelengths or angles of incidence. Just the intensity of the light emitted by one light source can be changed, or the intensity of the light emitted by two or more light sources can be changed. The intensity of the emitted light can be changed, for example, by the following means. Changing the intensity of the emitted light will also be referred to as light adjustment, hereinafter.

(1) Changing the intensity of the light emitted by the light sources by time division emission.
(2) Changing the input value of one or both the current and voltage of the light source.

Light-emitting diodes (LEDs) can be employed as light sources, as set forth above. The actual methods of light adjustment in the drive circuits of LEDs can be roughly divided into the following two types.

One is pulse width modulation (PWM) and the other is analog light adjustment.

In PWM, the brightness is adjusted by controlling the period between the illumination and extinguishment of an LED element. Generally, the brightness is controlled by adjusting the duty ratio of a PMW signal (the ratio of the ON time among the ON and OFF times). Commonly, the ON/OFF frequency can be set to about 50 Hz to about 32 KHz. When the frequency of repeated illumination and extinguishment is low, the human eye senses a “flickering.” Thus, an adequately high PMW signal frequency is desirable. A backlight unit employed in a display can be set to about 100 Hz to 10 KHz. Generally, about 200 Hz is employed. In applications such as machine vision that are employed on production lines and the like, it can be set to about 1 KHz. A frequency without flickering or chirping can be selected based on the application. The chirping referred to here is a phenomenon whereby the substrate resonates due to contraction and expansion of the capacitor when a variation in voltage occurs in the output capacitor during PWM control. The duty ratio can be set as desired, such as to about 1% to reduce light. The brightness control range is large. The designing of the control circuit is also relatively easy.

In analog light adjustment, the level of the current provided to the LED element is varied to adjust the brightness. Brightness increases when the current level is raised, and decreases when it is lowered. In analog light adjustment, the voltage level supplied from the exterior can be varied in analog manner using the electronic volume, variable resistor, or the like. The flickering does not occur in analog light adjustment. The light can be adjusted (reduced) down to about 10% on the low brightness side. From the perspective of color reproducibility, the use of a range to about 20% is desirable.

It is also possible to employ PWM control and analog light adjustment in combination. It is also possible to lower the current level in PMW control.

The chromaticity of the light emitted by the backlight unit can be adjusted by, as a specific example, conducting feedback control with a pre-established program that sends the results of chromaticity evaluation in the form of measurement by chromaticity measuring element to an LED track circuit. Providing a control element that changes the intensity of the light emitted by at least one light source based on the chromaticity measured by such a chromaticity measuring element makes it possible to automate the chromaticity adjustment of the emitted light. However, the chromaticity of the light emitted by the backlight unit can also be adjusted by adjusting the level of the current from the exterior manually in analog light adjustment.

An embodiment of adjusting the chromaticity of the light emitted by the backlight unit by varying the intensity of the light emitted by at least one light source based on the results of chromaticity evaluation has been described above. However, the present invention is not limited to the above embodiment. Embodiments of controlling the intensity of the light emitted by one or more light sources based on set current or voltage data that have been stored in a control element in advance based on the passing of a number of years following shipment of the product or a cumulative value for the number of hours the light source has been ON, and not based on the results of chromaticity evaluation, are additional examples of embodiments of the present invention.

<Configuration of the Liquid Crystal Display Device>

The above backlight unit can be combined with a liquid crystal panel to configure a liquid crystal display device. The liquid crystal panel comprises at least a liquid crystal cell. The mode used to drive the liquid crystal cell is not specifically limited. Various modes can be used, such as twisted nematic (TN), super twisted nematic (STN), vertical alignment (VA), in-plane switching (IPS), and optically compensated cells (OCBs).

The liquid crystal panel normally comprises at least a viewer side polarizer, a liquid crystal cell, and a backlight-side polarizer. It is desirable for the viewer side polarizer and the backlight side polarizer to have protective films (polarizer-protecting films) on one or both surfaces. A laminate having one or more protective films on a polarizer is called a polarizing plate. In one mode of implementing a liquid crystal display device, a liquid crystal cell in which a liquid crystal layer is sandwiched between opposing substrates on which at least one electrode is provided. The liquid crystal cell is disposed between two polarizing plate. The liquid crystal display device is equipped with a liquid crystal cell in which a liquid crystal is sealed between upper and lower substrates. The state of orientation of the liquid crystals is changed by applying a voltage to display an image. As needed, accompanying functional layers such as polarizer protective films, optical compensation members that conduct optical compensation, and adhesive layers can be present. Surface layers such as forward-scattering layers, primer layers, antistatic layers, and undercoat layers can also be disposed in addition to (or instead of) color filter substrates, thin-film transistor substrates, lens films, diffusion sheets, hard coat layers, antireflective layers, low-reflective layers, and antiglare layers.

As set forth above, ultraviolet light sources can be used as one type of light source. In that case, ultraviolet light will normally be contained in the light emitted from the backlight unit. In this case, it is desirable to dispose a member having the property of absorbing or reflecting ultraviolet light at some position in the backlight unit or liquid crystal panel. Thus, it is possible to prevent ultraviolet light from being emitted from the display surface of the liquid crystal display device, or to reduce the amount of ultraviolet light emitted. It is also desirable to dispose a member having the property of absorbing or reflecting ultraviolet light in at least either the backlight unit or the liquid crystal panel to prevent ultraviolet light from entering the liquid crystal panel or to reduce the amount of ultraviolet light entering the liquid crystal panel. From the perspective of efficiently using ultraviolet light as exciting light for phosphor, such a member is desirably disposed in a position in the liquid crystal device that is far from the wavelength conversion member. The property of absorbing or reflecting ultraviolet light can be imparted to a member positioned on the nearest liquid crystal panel side of the backlight unit or to a protective film on the backlight side of the backlight side polarizer of the liquid crystal panel. For example, by adding a UV radiation-absorbing agent, it is possible to impart the property of absorbing UV light to the above member. The UV radiation-absorbing agent can be an organic or inorganic material. Examples of organic materials are benzotriazole compounds, triazine compounds, and the like. Examples of inorganic materials are titanium oxide, tin oxide, zinc oxide, and other nanosize colloidal particles and the like. When employing particles as a UV radiation-absorbing agent, they can double as scattering particles. Particles that are about 0.5 μm to 20 μm in size are suitable as such particles.

An aspect of the present invention as set forth above makes it possible to control the chromaticity of light emitted by a backlight unit by a simple means of changing the intensity of the light emitted by a light source by using two or more light sources having differing maximum emission wavelengths or angles of incidence as the light sources of a backlight unit. Thus, it is possible to eliminate or moderate the tinting of white light emitted by the backlight unit.

The whiteness of the light emitted by the backlight unit can be indicated with the coordinates of a chromaticity point on a chromaticity diagram as set forth above. This is also sometimes indicated by the color temperature (Kelvin color temperature). The color temperature can be measured with a known colorimeter. The whiteness of the light emitted by the backlight unit can be 5,000 K to 7,000 K as a design color temperature for the white light of a liquid crystal display device, for example. However, this range is not a limitation. A setting lower than 5,000 K or higher than 7,000 K is also possible based on the application of the flat panel display into which the backlight unit is mounted. The light emitted by the backlight unit in the liquid crystal display device passes through the liquid crystal panel and finally exits through the surface of the liquid crystal display device. Thus, the actual color can be changed by the polarizing plate, liquid crystal cell, color filters, and the like in the liquid crystal panel. The light emitted by the backlight unit can be designed taking into account the effect on the actual color of various members that are contained in the liquid crystal panel.

### EXAMPLES

The present invention will be more specifically explained on the basis of Examples below. The material, amount used, proportion, treatments, treating procedure, and the like shown in the following Examples can be appropriately modified as long as the modifications thereof do not depart from the gist of the present invention. Accordingly, the scope of the present invention should not be interpreted limitedly by the following Examples.

The following chromaticity was measured with a chromaticity luminance meter (SR-3 made by TOPCON Corp.).

Light sources 1 to 3 employed below were blue LED light sources that emitted light with a single peak having the maximum emission wavelength indicated below.

Light source 1: 455 nm
Light source 2: 465 nm
Light source 3: 440 nm

### Preparation of Liquid Crystal Display Device 101

### Comparative Example

A wavelength conversion member in which barrier films were deposited on both surfaces of a wavelength conversion layer containing quantum dot 1 (green phosphor) with a maximum emission wavelength of 520 nm and quantum dot 2 (red phosphor) with a maximum emission wavelength of 630 nm was employed as the wavelength conversion member.

The backlight unit was a direct under type backlight unit in which just light source 1 was disposed as light source. In order from the wavelength conversion member side, a scattering sheet, two prism sheets with prism arrays set at right angles to each other, a reflective polarizer, and a scattering sheet were disposed in the backlight unit. These members had reflective properties.

The quantities of the various quantum dots were adjusted in the wavelength conversion member so that white light of x=0.33 and y=0.33 in the chromaticity diagram would be obtained as the light emitted by the backlight unit. The brightness of the light emitted by the backlight unit was measured with a chromaticity luminance meter (SR3 made by TOPCON Corp.) at 250 cd/m². The chromaticity in the state of the above color coordinates will be referred to as the initial setting state, hereinafter, and the intensity of the light emitted by the light sources set in this manner will be referred to as the intensity of the initial setting.

After changing the scattering sheet of liquid crystal display device 101 to the scattering sheet of a different lot, light emitted at the intensity of the initial setting was caused to be emitted by light source 1 and the color coordinates were measured by a colorimeter.

After changing the wavelength conversion member of liquid crystal displayer device 101 to the wavelength conversion member of the barrier films of a different lot, light emitted at the intensity of the initial setting was caused to be emitted by light source 1 and the color coordinates were measured by a colorimeter.

After changing the wavelength conversion member of liquid crystal display device 101 to one in which the emission efficiency of the quantum dots had been intentionally lowered by imparting change over time by means of an acceleration test based on irradiation with light, light emitted at the intensity of the initial setting was caused to be emitted by light source 1 and the color coordinates were measured by a colorimeter.

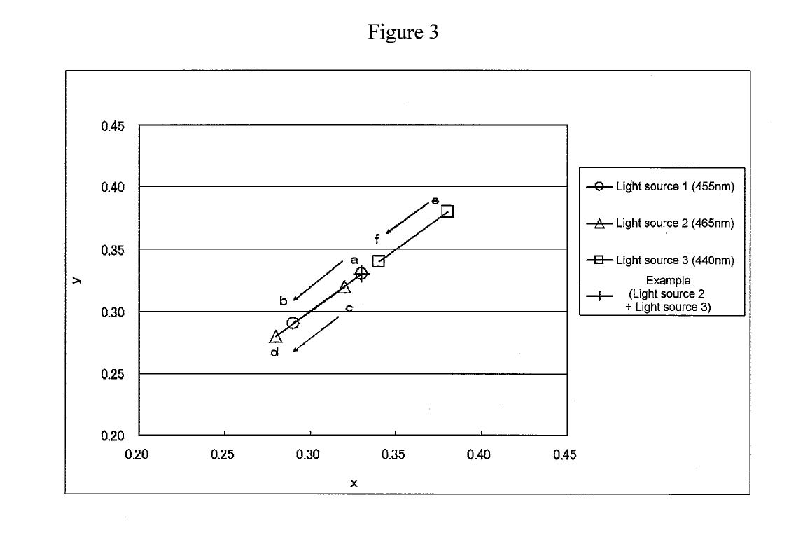

The color coordinates that were measured after making the changes indicated above are given in Table 1. The position of the color coordinates measured in liquid crystal display device 101 for the initial setting state and into which the wavelength conversion member that had been changed over time by means of an acceleration test was mounted are given in the chromaticity diagram of FIG. 3.

TABLE 1

| | | Color coordinates | | Position in |
|---|---|---|---|---|
| Liquid crystal display device 101 | | x | y | FIG. 3 |
| Light source 1 | Initial setting | 0.33 | 0.33 | a |
| (Center emission | state | | | |
| wavelength 455 nm) | Scattering sheet | 0.35 | 0.34 | — |
| | changed | | | |
| | Barrier film | 0.31 | 0.31 | — |
| | changed | | | |
| | Change over | 0.29 | 0.29 | b |
| | time in | | | |
| | wavelength | | | |
| | conversion | | | |
| | member | | | |

### Preparation of Liquid Crystal Display Device 102

### Comparative Example

With the exception that just light source 2 was employed as the light source, the intensity of light source 2 was adjusted to give the initial setting brightness set in liquid crystal display device 101 and the color coordinates of the initial setting state were measured in the same manner as for liquid crystal display device 101.

Subsequently, the wavelength conversion member was changed to one that had been caused to change over time in the same manner as above, light source 2 was caused to emit light at the initial setting intensity, and the color coordinates were measured with a colorimeter.

The results are given in Table 2 below.

TABLE 2

| | | Color coordinates | | Position in |
|---|---|---|---|---|
| Liquid crystal display device 102 | | x | y | FIG. 3 |
| Light source 2 | Initial setting | 0.32 | 0.32 | c |
| (Center emission | state | | | |
| wavelength 465 nm) | Change over | 0.28 | 0.28 | d |
| | time in | | | |
| | wavelength | | | |
| | conversion | | | |
| | member | | | |

### Preparation of Liquid Crystal Display Device 103

### Comparative Example

With the exception that just light source 3 was employed as the light source, the intensity of light source 3 was adjusted to give the initial setting brightness set in liquid crystal display device 101 and the color coordinates of the initial setting state were measured in the same manner as for liquid crystal display device 101.

Subsequently, the wavelength conversion member was changed to one that had been caused to change over time in the same manner as above, light source 3 was caused to emit light at the initial setting intensity, and the color coordinates were measured with a colorimeter.

The results are given in Table 3 below.

TABLE 3

| | | Color coordinates | | Position in |
|---|---|---|---|---|
| Liquid crystal display device 103 | | x | y | FIG. 3 |
| Light source 3 | Initial setting | 0.38 | 0.38 | e |
| (Center emission | state | | | |
| wavelength 440 nm) | Change over | 0.34 | 0.34 | f |
| | time in | | | |
| | wavelength | | | |
| | conversion | | | |
| | member | | | |

In liquid crystal display device 101, white light without tinting could be obtained as light emitted by the backlight unit in the initial setting state (position a in FIG. 3).

However, the use of the wavelength conversion member that had been changed over time caused the color coordinates of the white light emitted by the backlight unit to become intensely bluish (position b in FIG. 3).

For liquid crystal display device 102, the white light obtained in the initial setting was somewhat bluish (position c in FIG. 3), and the use of the wavelength conversion member that had been changed over time intensified the bluish level of the white light (position d in FIG. 3).

For liquid crystal display device 103, the white light obtained in the initial state had a yellowish tint (position e in FIG. 3), while the position of the white light in the chromaticity diagram was shifted by changing the wavelength conversion member (position fin FIG. 3).

As set forth above, when just one type of light source is employed, a change in the constituent members will cause the white light that is emitted by the backlight unit to end up shifting between a and b, c and d, and e and fin the chromaticity diagram.

### Preparation of Liquid Crystal Display Device 104

### Example

With the exception that two light sources in the form of light source 2 and light source 3 were simultaneously employed, in the same manner as in liquid crystal display devices 102 and 103, the intensity of the light emitted by each of the light sources was reduced by 50% from the initial setting state set in liquid crystal display devices 102 and 103.

The intensity ratio of the light emitted by the two light sources was changed from the above state (specifically, the relative intensity of light source 2 was increased relative to the intensity of light source 3) to cause the backlight layer to emit untinted white light of ?c=0.33 and y=0.33. When this was adopted as the initial setting state and the wavelength conversion member was changed to a wavelength conversion member that had been changed over time, weakening the relative intensity of light source 2 relative to that of light source 3 made it possible to effect an adjustment to white light of x=0.33 and y=0.33 (see Table 4 below).

TABLE 4

| | | Color coordinates | | Position in |
|---|---|---|---|---|
| Liquid crystal display device 104 | | x | y | FIG. 3 |
| Light sources | Initial setting | 0.33 | 0.33 | a |
| 2 + 3 (Center | state | | | |
| emission | Change over | 0.33 | 0.33 | a |
| wavelengths 465 nm/ | time in | | | |
| 440 nm) | wavelength | | | |
| | conversion | | | |
| | member | | | |

In a backlight unit in which white light was obtained by using blue light as the exciting light of phosphors to obtain the emission of green light by a phosphor and the emission of red light by a phosphor, and mixing them with blue light emitted without exciting a phosphor, the actual color of the light emitted was easily changed in the blue-yellow direction in the chromaticity diagram. In such cases, the actual color of the light emitted by the backlight unit by causing light to be emitted by the various light sources is desirably positioned by sandwiching the white light point that one is attempting to achieve by design to the blue-tinted side and to the yellow-tinted side in the manner of light source 2 and light source 3, respectively. Doing this can facilitate adjustment of the intensity of the light emitted by the various light sources to achieve the white light that is desired by design.

The example of two light sources having differing maximum emission wavelengths has been given above. However, as set forth above, it is also possible to reduce or moderate the tinting of white light by using two or more light sources of differing angles of incidence.

The present disclosure relates to the subject matter contained in Japanese Patent Application No. 2014-202425 filed on Sep. 30, 2014, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A backlight unit, which comprises:
two or more light sources, and
a wavelength conversion member positioned on each of optical paths of light emitted by the two or more light sources, wherein
the wavelength conversion member comprises a wavelength conversion layer containing at least a phosphor emitting green light when excited with exciting light and a phosphor emitting red light when excited with exciting light; and
at least either maximum emission wavelengths or angles of incidence of entry into the wavelength conversion member of the light emitted by the two or more light sources differ.

2. The backlight unit according to claim 1, wherein the maximum emission wavelengths of the two or more light sources are within a range from the wavelength range of blue light to the wavelength range of ultraviolet light.

3. The backlight unit according to claim 1, which comprises a control element that is capable of controlling an intensity of light emitted by at least one of the two or more light sources independently of an intensity of light emitted by another light source.

4. The backlight unit according to claim 3, wherein the control element can control the intensity of the light emitted by each of the two or more light sources independently of the intensity of the light emitted by the other light sources.

5. The backlight unit according to claim 1, wherein maximum emission wavelengths of the two or more light sources differ.

6. The backlight unit according to claim 1, wherein the light sources are light-emitting diodes and the wavelength conversion member is a sheet-shaped member.

7. The backlight unit according to claim 1, which comprises at least one member having a reflective property at least on an emission side or on a light source side.

8. The backlight unit according to claim 7, which comprises the member having a reflective property in the form of at least one sheet-shaped member.

9. The backlight unit according to claim 1, which is a direct under type backlight unit.

10. The backlight unit according to claim 1, which comprises a chromaticity measuring element that measures chromaticity of light emitted by the wavelength conversion member.

11. The backlight unit according to claim 10, which comprises a control element that changes an intensity of light emitted by at least one of the two or more light sources based on the chromaticity that is measured by the chromaticity measuring element.

12. A liquid crystal display device, which comprises:
a backlight unit; and
a liquid crystal panel, wherein
the backlight unit comprises:
two or more light sources, and
a wavelength conversion member positioned on each of optical paths of light emitted by the two or more light sources, wherein
the wavelength conversion member comprises a wavelength conversion layer containing at least a phosphor emitting green light when excited with exciting light and a phosphor emitting red light when excited with exciting light; and
at least either maximum emission wavelengths or angles of incidence of entry into the wavelength conversion member of the light emitted by the two or more light sources differ.

13. The liquid crystal display device according to claim 12, wherein the maximum emission wavelengths of the two or more light sources are within a range from the wavelength range of blue light to the wavelength range of ultraviolet light.

14. The liquid crystal display device according to claim 12, wherein the backlight unit comprises a control element that is capable of controlling an intensity of light emitted by at least one of the two or more light sources independently of an intensity of light emitted by another light source.

15. The liquid crystal display device according to claim 14, wherein the control element can control the intensity of the light emitted by each of the two or more light sources independently of the intensity of the light emitted by the other light sources.

16. The liquid crystal display device according to claim 12, wherein maximum emission wavelengths of the two or more light sources differ.

17. The liquid crystal display device according to claim 12, wherein the light sources are light-emitting diodes and the wavelength conversion member is a sheet-shaped member.

18. The liquid crystal display device according to claim 12, wherein the backlight unit comprises at least one member having a reflective property at least on an emission side or on a light source side.

19. The liquid crystal display device according to claim 12, wherein the backlight unit is a direct under type backlight unit.

20. The liquid crystal display device according to claim 12, wherein the backlight unit comprises a chromaticity measuring element that measures chromaticity of light emitted by the wavelength conversion member.
